(19) United States
(12) Patent Application Publication
(10) Pub. No.: US 2005/0268331 A1
(43) Pub. Date: Dec. 1, 2005

(54) Extension to the firewall configuration protocols and features

(76) Inventors: Franck Le, Irving, TX (US); Stefano Faccin, Dallas, TX (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/852,680

(22) Filed: May 25, 2004

(51) Int. Cl. H04L 9/00

(52) U.S. Cl. 726/11

(57) ABSTRACT

A network implementing at least one firewall for providing protection for users on the network. The network includes at least one host system protected by the at least one firewall, the host system being configured to send and receive information from external host systems through the at least one firewall. The at least one firewall including installation means for installing policy rules that are transmitted from at least one network entity to the at least one firewall. The policy rules include an option field for allowing the at least one network entity to send additional information to the firewall on at least one state to be created. The additional information is optionally used by the at least one firewall to perform services on data travelling through the at least one firewall.

### FIELD OF THE INVENTION

The present invention relates to firewalls used in most Internet Protocol networks to reduce the threats and/or attacks against users of those networks and particularly to using firewalls in new applications, such as Voice over IP applications.

### BACKGROUND OF THE INVENTION

A firewall is a packet filtering device that matches an incoming packet against a set of policy rules and applies the appropriate actions to the packet. The firewall essentially filters incoming packets coming from external networks to the network protected by the firewall and either accepts, denies or drops the incoming packets of information. Current firewalls may use a packet filtering method, a proxy service method or a stateful inspection method to control traffic flowing into and out of the network. The packet filtering method allows the firewall to analyze incoming packets against a set of filters. Packets that are allowed through the filters are sent to the requesting/receiving system and all other packets are discarded. The proxy service method enables the firewall to retrieve information sent from the Internet and then the firewall sends the information to the requesting/receiving system and vice versa. The stateful inspection method enables the firewall to compare certain key parts of the packet to a database of trusted information. Information travelling from inside the firewall to the outside is monitored for specific defining characteristics and then incoming information is compared to these characteristics. If the comparison yields a reasonable match, the information is allowed through, otherwise, it is discarded.

Current firewalls use policy rules for decisions on data packet treatment. The policy rules include a 5-tuple and an associated action. The 5-tuple includes a source IP address, a destination IP address, a transport protocol, a source port number and a destination port number. The source address is the IP address from where the data originates. The destination address is the IP address to where the data is headed. The protocol is the protocol carried in the IP data packet. The source port is the transport layer port from where the data originates and the destination port is the transport layer port to where the data is headed. When an incoming data packet matches the 5-tuple policy rule, the firewall applies an appropriated policy rule action to the data packet. Policy rule actions implemented by the firewall are an allow action for enabling the firewall to forward the packet through the firewall, a deny action for enabling the firewall to block the data packet and discard it, and an other action for enabling the firewall to log, divert or process the data packet in a way that is different from the allow action and the deny action. Therefore, based on the 5-tuples in the policy rules, the firewall decides to either let incoming packets pass through the firewall, drop incoming packets or perform another function, such as logging the incoming packet.

In addition to filtering packets based on the source IP address, destination IP address, Protocol, and port numbers, most firewalls perform additional filtering functionality on other fields and perform many other operations to prevent attacks. For example, most firewalls include a Transmission Control Protocol (TCP) Sequence Verifier feature for keeping track of TCP sequence numbers in packets that pass thorough the firewall. During TCP connection setup, when nodes exchange TCP SYN, TCP SYN ACK and TCP ACK messages, they exchange and agree on the values of TCP sequence numbers to be used during communications between the nodes. The firewall typically learns the initial values of the sequence numbers from the connection setup messages. Thereafter, every packet in a TCP session includes a sequence number in the TCP header information. The sequence number is the mechanism used to allow reliable communications between hosts. The sequence number identifies each packet of data so that a receiving host can reassembly the stream of incoming packets in the correct order and acknowledge each individual packet as it is received. If a sequence number is not acknowledged within a predetermined period of time, the sending host retransmits the unacknowledged packet. If the retransmission and the acknowledgment pass each other on the network, the receiving host discards the duplicate packet because of the previously received sequence number. The Sequence Verifier feature of a firewall enables the firewall to watch all traffic flows going through the firewall and keep track of the sequence numbers in the packets. If the firewall receives a packet with an incorrect sequence number, the firewall will consider the packet to be out of state and drop the packet.

Although firewalls provides security for networks, they are also obstacles to many application since firewalls using the 5-tuple rules only allow specific applications, for example web browsing from a node in the network protected by the firewall. Other applications, such as IP telephony and peer-to-peer applications, with dynamic properties do not work with firewalls.

Several solutions are created to enable any application to traverse a firewall. One solution is the Next Step Of Signaling (NSIS) firewall protocol that is a path-coupled protocol carried over the NSIS Network Transport Layer Protocol. This Network Transport Layer Protocol is used to open pin-holes in the firewalls and thereby enable any type of communication between endpoints across networks, even in the presence of firewalls. Specifically, the NSIS Network Transport Layer Protocol is used to install such policy rules for enabling NSIS signalling messages in all firewalls along the data path and the firewalls are configured to forward data packets matching the policy rules provided by a NSIS Signaling Layer Protocol (NSLP). Therefore, applications located at endpoints/hosts establish communication between them and use the NSLP signalling to establish policy rules on a data path which allows any type of data between the hosts to travel unobstructed from one endpoint to another.

According to the NSIS protocol, a data sender that intends to send data to a data receiver starts the NSLP. A NSIS initiator at the data sender sends NSLP signalling request messages towards the address of the data receiver. The NSLP request messages are processed each time they are passed through a NSIS forwarder, i.e., a signalling entity, between a NSIS initiator and NSIS responder, that propagates NSIS signalling through the network. Each NSIS forwarder in the network processes the message, checks local policies for authorization and authentication, possibly creates policy rules and forwards the signalling message to the next NSIS node. The request message is forwarded until it reaches the NSIS responder which checks the received message and generates response message(s) that are sent to the requesting NSIS initiator through the NSIS forwarder. The response messages are also processed at each NSIS forwarder in the data path. After the requesting NSIS initiator receives a successful response message(s), the data sender associated with the requesting NSIS initiator can send any type of data through the data path established during the NSIS setup to the data receiver associated with the responding NSIS responder. This creates a pinhole in the firewall, wherein data not implementing the conventional policy rules will be allowed through the firewall via the data path established during the NSIS setup.

Nevertheless, current firewall configuration protocols, such as NSIS, only allows a limited set of parameters to be included in the signalling messages. Because of the limited number of parameters allow in the protocols, the firewall is provided with limited information when data is transmitted between nodes and some essential information may not be provided to the firewall. In the absence of the needed information, some firewall functions may be disabled thereby lowering the protection provided by the firewall. For example, if a terminal in a network protected by a firewall establishes a NSIS connection with another terminal, then moves to a different subnet that is protected by a new firewall and changes its IP address, the terminal may use the NSIS protocol to create the necessary packet filters in new firewall in order to let incoming packets to the terminal's new IP address pass through the new firewall. However, because of the limited number parameters allowed in current firewall configuration protocols, the terminal will not be able to provide the TCP Sequence numbers of the packet flows between the terminal and its correspondent nodes, and the new firewall will be unable to perform TCP Sequence verification. This exposes the network protected by the new firewall to potential threats and/or attacks.

### SUMMARY OF THE INVENTION

According to one aspect of the invention, there is provided a network implementing at least one firewall for providing protection for users on the network. The network includes at least one host system protected by the at least one firewall, the host system being configured to send and receive information from external host systems through the at least one firewall. The at least one firewall including installation means for installing policy rules that are transmitted from at least one network entity to the at least one firewall. The policy rules include an option field for allowing the at least one network entity to send additional information to the firewall on at least one state to be created. The additional information is optionally used by the at least one firewall to perform services on data travelling through the at least one firewall.

According to another aspect of the invention, there is provided a firewall for providing protection for users on a network. The firewall includes installation means for installing policy rules that are transmitted from at least one network entity to the firewall, wherein the policy rules comprise an option field for allowing the at least one network entity to send additional information to the firewall on at least one state to be created. The additional information is optionally used by the firewall to perform services on data travelling through the firewall.

According to another aspect of the invention, there is provided a host system including a firewall for providing protection. The host system also includes installation means, on the firewall, for installing policy rules that are transmitted from at least one network entity through the firewall. The policy rules include an option field for allowing the at least one network entity to send additional information to the firewall on at least one state to be created. The additional information is optionally used by the firewall to perform services on data travelling through the firewall.

According to another aspect of the invention, there is provided a method for protecting systems connected to at least one firewall by providing additional information to the at least one firewall on states to be created. The method includes the steps of transmitting policy rules from at least network entity connected to the at least one firewall and installing the policy rules on the at least one firewall. The policy rules comprise an option field for allowing the at least one network entity to send additional information to the at least one firewall on at least one state to be created. The method also includes the step of optionally using the additional information by the at least one firewall to perform services on data travelling through the at least one firewall.

According to another aspect of the invention, there is provided an apparatus for protecting systems connected to at least one firewall by providing additional information to at least one firewall on states to be created. The apparatus includes transmitting means for transmitting policy rules from at least one network entity connected to the at least one firewall. The apparatus also includes installation means for installing the policy rules on the at least one firewall, wherein the policy rules comprise an option field for allowing the at least one network entity to send additional information to the at least one firewall on at least one state to be created. The apparatus further includes implementation means for optionally using the additional information by the at least one firewall to perform services on data travelling through the at least one firewall.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates a network that includes firewalls for protecting end users from threats and attacks from outside users;

FIG. 2 illustrates the steps implemented in setting up communications in a network that implements the NSIS protocol;

FIG. 3a illustrates the format of message transmitted in the inventive system;

FIG. 3b illustrates the NSLP objects in each message type;

FIG. 4 illustrates the elements of the inventive policy rule object; and

FIG. 5 illustrates the steps implemented by a create session request message in an embodiment of the invention.

### DESCRIPTION OF EMBODIMENTS

Reference will now be made in detail to the preferred embodiments of the present invention, examples of which are illustrated in the accompanying drawings. The present invention described below extends firewall configuration protocols to carry more information about the states to be created during communications between network nodes.

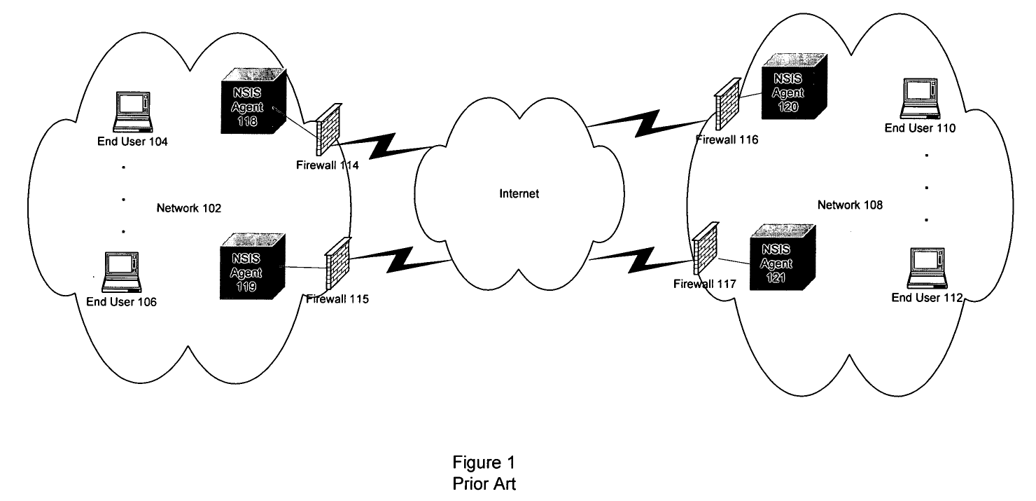

The present invention relates to extended firewall configuration protocols to enable an end user to include information on a state to be created. FIG. 1 illustrates a network that includes firewalls for protecting end users from threats and/or attacks from outside users. The network includes a first network 102 that includes multiple end users 104-106 and a second network 108 that includes end users 110-112. The network also includes firewalls 114 and 115 for protecting end users 104-106 from external attacks and firewalls 116 and 117 for protecting end user 110-112 from external attacks. It should be apparent to one skilled in the art, that firewalls 114-117 may include one or more packet filtering devices for matching packets travelling through those devices against a set of police rules and applying the appropriate action to the data packets. Although firewalls are place more toward the edge of a network, it should be apparent to one skilled in the art that firewalls 114-117 may be located at different locations in the network, for example, at enterprise network borders, within enterprise networks, or at mobile phone gateways. It should also be apparent to one skilled in the art, that networks 102 and 108 may include other network entities, such as servers, that may also transmit information through firewalls 114-117.

In one embodiment of the invention, firewalls 114-117 may implement Next Step of Signaling (NSIS) protocol where after communication setup between endpoints/hosts, any communication between the endpoints across the network is enabled, even in the presence of firewalls. During communication setup, firewalls 114-117 are configured in such a way that NSIS signalling messages are allowed to traversed them. The NSIS signalling messages exchanged between the hosts during communication setup are used to install appropriate policy rules in all firewalls 114-117 along the communications path and firewalls 114-117 are configured to forward subsequent data packets matching the policy rules provided by the NSIS signalling messages. This allows data to travel from one end point to another end point unobstructed by firewalls 114-117. In order to run NSIS signalling across a data path, it is necessary that each firewall in the data path have an associated NSIS agent 118-121.

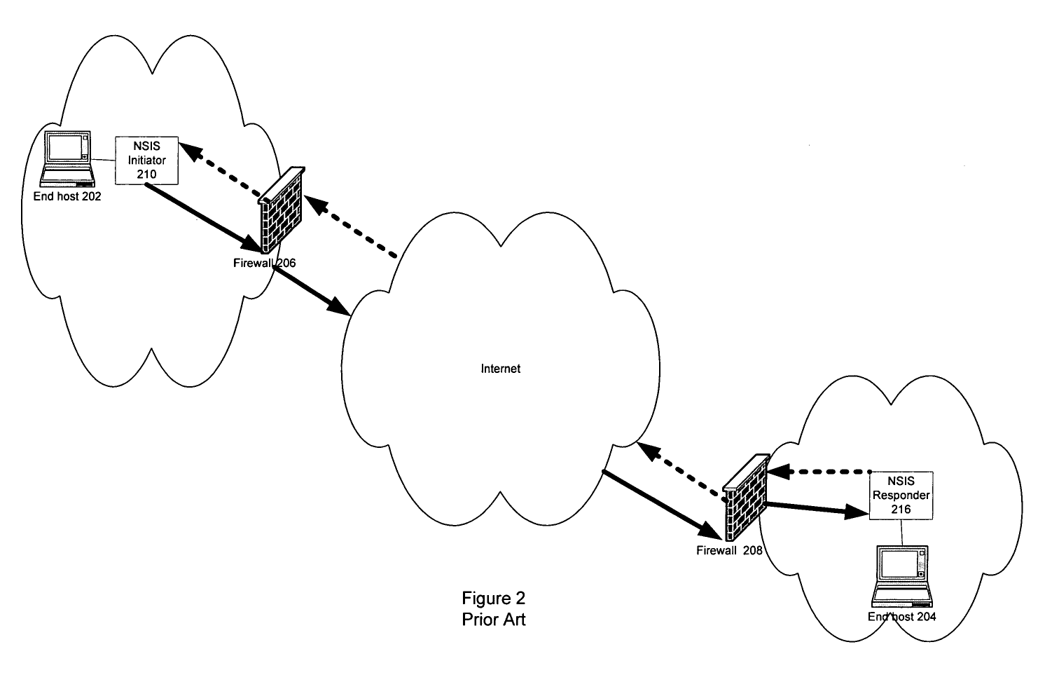

FIG. 2 illustrates the steps implemented in setting up communications in a network that implements the NSIS protocol. According to FIG. 2, both end hosts 202 and 204 are behind firewalls 206 and 208 that are connected via the Internet. Firewalls 206 and 208 provide traversal service for NSIS Signaling Layer Protocol (NSLP) in order to permit NSIS messages to reach end hosts 202 and 204. As such, during communication setup, firewalls 206 and 208 process NSIS signalling and establish appropriate policy rules so that subsequently received data packets conforming to the policy rules can traverse firewalls 206 and 208. Trust relationships and authorization are very important for the protocol machinery. Various kinds of trust relationships, such as peer-to-peer trust relationship, intra-domain trust relationship, end-to-middle trust relationship, and one or more trust relationships may exists between network nodes.

Specifically, during communications setup, NSLP for firewall traversal is carried over the NSIS Transport Layer Protocol. NSLP messages are initiated by a NSIS initiator 210, handled by NSIS forwarders 206 and 208 and processed by NSIS responder 216. A data sender, such as end host 202, that intends to send data messages to a data receiver, such as end host 204, must start its NSLP signalling, whereby NSIS initiator 210 associated with the data sender starts NSLP signalling towards the address of the data receiver. The NSLP request messages from NSIS initiator 210 are process each time the messages pass through NSIS forwarders 206 and 208 that support NSLP functions. NSIS forwarders 206 and 208 process the messages, check local policies for authorization and authentication, possible create policy rules and forward the signalling messages to the next node. As such, the request messages are forwarded until it reaches NSIS responder 216. NSIS responder 216 checks the received message, performs the applicable processes and generates response messages that are sent back to NSIS initiator 210 via the same communications path as the request messages. The response messages are also processed at NSIS forwarders 206 and 208 during transmission from NSIS responder 216 to NSIS initiator 210. Upon receiving a successful response message, the data sender may thereafter send data flows to the data receiver.

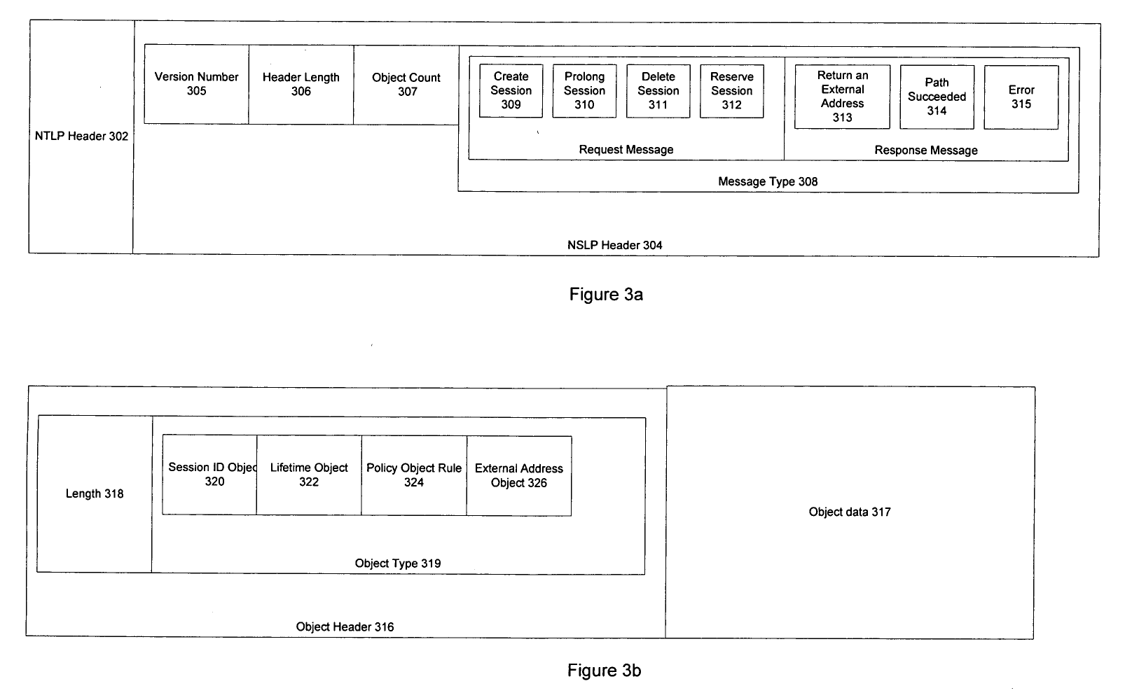

FIG. 3a illustrates the format of a message transmitted in the inventive system. All NSIS messages include a NSIS Transport Layer Protocol header 302 and a NSLP header 304. A NSLP node uses header 300 to distinguish between a request message and a response message. NSLP header 304 includes a version number 305, a header length 306 for specifying the length of the NSLP payload in bytes, object count number 307 for specifying the number of objects that follow after NSIS header 300 and the message type 308 for specifying if the message is a response or request message. For request messages, four sub-types are defined in message type 308. The sub-types are create-session 309, prolong session 310, delete session 311 and reserve session 312. Create-session 309 request message is used to create policy rules on the firewalls so that data packets of a specified data flow can traverse the firewall. Prolong session 310 request message is used to extend the lifetime of a NSLP session. The NSIS initiator uses the prolong session request message to request a certain lifetime extension. Delete session request message 311 is used to delete a NSLP session. Reserve session 312 request message is used to reserve a session. For response messages, three sub-types are defined in message type 308. The sub-types are return-an-external address 313, path succeeded 314 and error 315. Return-an-external address 313 response message is sent as a successful reply to a reserve external address request. Path succeeded 314 response message is sent as a successful reply to a create session request message 309. Error response message 315 reports any error occurring at the NSIS forwarder or NSIS responder to the NSIS initiator.

Each message type includes one ore more NSLP objects which carry the actual information about policy rules, lifetimes and error conditions. FIG. 3b illustrates the NSLP objects in each message type. All objects share the same object header 316 which is followed by the object data 317. Object header 316 includes the total length 318 of the object and the object type 319 that identifies data 317. The format of object data 317 depends on object type 319. Object type 319 include a session id object 320 for providing a randomly generated session ID handed by the NSIS initiator to the NSIS session at a particular node, the lifetime object 322 for indicating the lifetime of a NSLP session, policy rule objects 324 that includes the flow information for the data traffic from the data sender to the data receiver, and an external address object 326 that includes a reserved external address and if applicable a port number.

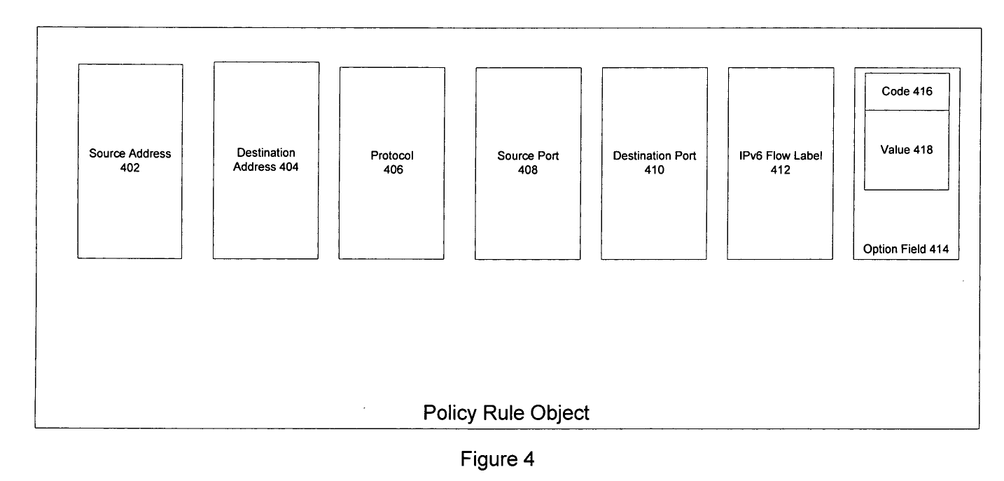

FIG. 4 illustrates the elements of the inventive policy rule object. The policy rule object includes a source address 402, a destination address 404, a protocol 406, a source port 408, a destination port 410, and IPv6 flow label 412 and an option field 414. Source address 402 is the IP address from where the data originates. For example, if data sender 104 illustrated in FIG. 2 is sending data to data receiver 110, source address 402 will be the address of data sender 194. Destination IP address 404 is the IP address to where the data is headed. Again returning to FIG. 2, destination address 404 is either the data receiver's 110 address or the public address that data receiver 110 reserved for itself. Protocol 405 is the protocol carried in the IP data packet. Source port 408 is the transport layer port from where the data originates and destination port 410 is the transport layer port to where the data is headed. Option field 414 allows the end user to include additional information on the state to be created. Code 416 in option field 414 indicates the type of information that follows. For example, option field 414 may include a TCP sequence number that is required by a firewall for the firewall to perform TCP sequence verification. In this case, code 416 will be “TCP sequence number” and value 418 will include the TCP sequence numbers of the flows created when creating the states in the firewalls. As is apparent to one skilled in the art, option field 414 may be broken up to include multiple codes 416 and corresponding values 418. Various currently known means may be implemented to allow the firewall to determine how many values are provided by option field 414 and what each value represents.

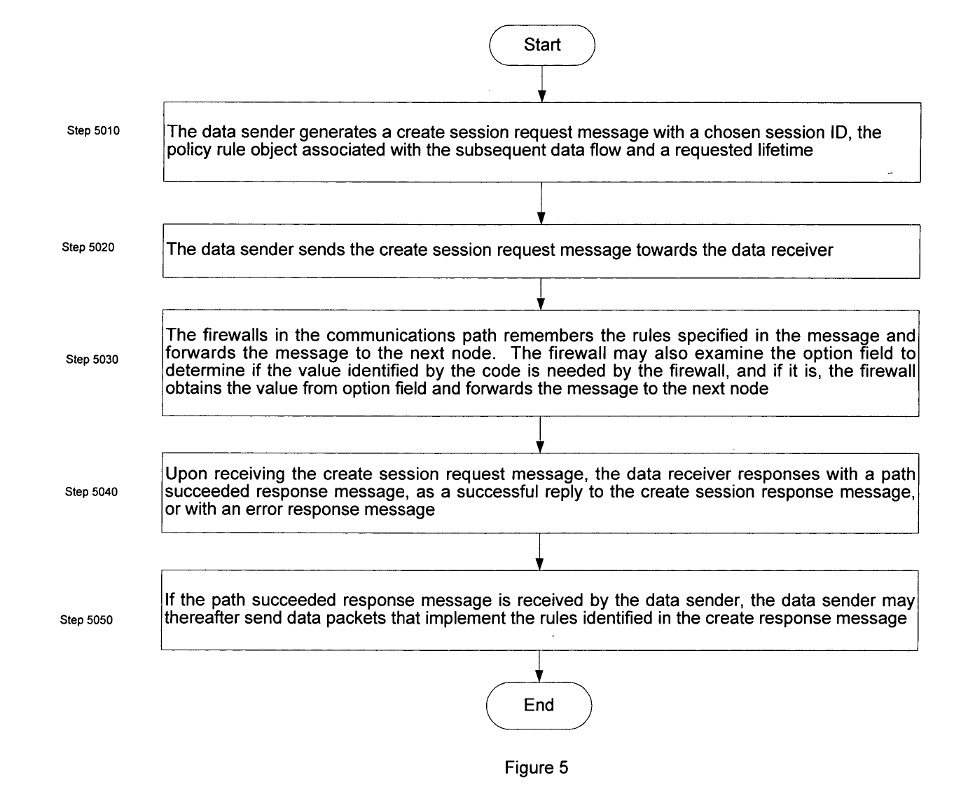

FIG. 5 illustrates the steps implemented by create-session message 309 for enabling communication between a data sender and a data receiver. Thereafter, both the data sender and the data receiver are enabled to exchange data packets even with one or more firewalls on the communications path. In step 5010 the data sender generates create-session request message 309 with a chosen session ID, the policy rule object associated with the subsequent data flow and a requested lifetime. In Step 5020, the data sender sends create-session request message 309 towards the data receiver. In Step 5030, the firewalls in the communications path remember the rules specified in the message and forward the message to the next node. The firewall may also examine the option field to determine if the value identified by code is needed by the firewall. If it is, the firewall obtains the value from option field prior to forwarding the message to the next node. In Step 5040, upon receiving create-session 309 request message, the data receiver responses with path succeeded 314 response message, as a successful reply to create-session 309 response message, or with error 315 response message. In Step 5050, if path succeeded 314 response message is received by the data sender, the data sender may thereafter send data packets that implement the rules identified in create-response message.

In another embodiment, the invention may be used in a network implementing IP security protocols (IPsec). IPsec provides security services at the IP layer by enabling a system to select required security protocols, determine the algorithm(s) to use for the service(s) and put in place any cryptographic keys that are required to provide the requested services. IPsec can be used to protect one or more communication paths between a pair of hosts, between a pair of security gateways, i.e., any intermediate system that implements IPsec protocols, or between a host and a security gateway.

IPsec uses Authentication Header (AH) protocol and Encapsulating Security Payload (ESP) protocol to provide traffic security. The AH protocol provides connectionless integrity, data origin authentication and an optional anti-replay service. The ESP protocol may provide confidentiality (encryption) and limited traffic flow confidentiality. It may also provide connectionless integrity, data origin authentication and an anti-replay service. The protocols may be applied alone or in combination with each other to provide a desired set of security services. Each protocol supports a transport mode for providing protection primarily for upper layer protocols and a tunnel mode which is applied to tunnelled IP packets.

Both the AH and ESP use security association which is a simplex “connection” that affords security services to the traffic carried by it. Security services are afforded to a security association by the use of the AH protocol or the ESP protocol, but not both. If both AH and ESP protection is applied to a traffic stream, then two or more security associations are created to afford protection to the traffic stream. Therefore, to secure typical, bi-directional communication between two hosts or between two security gateways, two security associations (one in each direction) are applied.

A security association is uniquely identified by a triple consisting of a Security Parameter Index (SPI) an IP destination address and a security protocol (AH or ESP) identifier. In the inventive system, a network implementing IPsec protocol may include the SPI in option field 414. Therefore, referring to FIG. 4, the policy rule object will include source address 402, destination IP address 404, protocol 405, option field 414 which includes the SPI value and optionally source port 408 and destination port 410. Code 416 in option field 414 will indicate that option field 414 includes the SPI that is required by a firewall for the firewall to implement the appropriate IPsec protocol(s).

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

1. An network implementing at least one firewall for providing protection for users on the network, the network comprising:
at least one host system protected by the at least one firewall, the host system being configured to send and receive information from external host systems through the at least one firewall; and
the at least one firewall comprising installation means for installing policy rules that are transmitted from at least one network entity to the at least one firewall, wherein the policy rules comprise an option field for allowing the at least one network entity to send additional information to the at least one firewall on at least one state to be created and the additional information is optionally used by the at least one firewall to perform services on data travelling through the at least one firewall.

2. The network of claim 1, wherein the option field comprises at least one code for indicating the type of information stored in the option field and at least one value for the information identified by the at least one code.

3. The network of claim 2, wherein the option field comprises at least one code for indicating that a Security Parameter Index used in a IP security protocol is stored in the option field and at least one value for the Security Parameter Index identified by the at least one code.

4. The network of claim 2, wherein the option field comprises at least one code for indicating that at least one TCP sequence number used during TCP communication is stored in the option field and at least one value for the at least one TCP sequence number identified by the at least one code.

5. The network of claim 1, wherein the option field comprises means for enabling the firewall to determine how many types of values are stored in the option fields.

6. A firewall for providing protection for users on a network, the firewall comprising:
installation means for installing policy rules that are transmitted from at least one network entity to the firewall, wherein the policy rules comprise an option field for allowing the at least one network entity to send additional information to the firewall on at least one state to be created and the additional information is optionally used by the firewall to perform services on data travelling through the firewall.

7. The firewall of claim 6, wherein the option field comprises at least one code for indicating the type of information stored in the option field and at least one value for the information identified by the at least one code.

8. The firewall of claim 7, wherein the option field comprises at least one code for indicating that a Security Parameter Index used in a IP security protocol is stored in the option field and at least one value for the Security Parameter Index identified by the at least one code.

9. The firewall of claim 7, wherein the option field comprises at least one code for indicating that at least one TCP sequence number used during TCP communication is stored in the option field and at least one value for the at least one TCP sequence number identified by the at least one code.

10. The firewall of claim 6, wherein the option field comprises means for enabling the firewall to determine how many types of values are stored in the option fields.

11. The firewall of claim 6, wherein the at least one network entity is one of a host system or a processing entity connected to a network.

12. A host system comprising a firewall for providing protection, the host system entity comprising:
installation means on the firewall for installing policy rules that are transmitted from at least one network entity through the firewall, wherein the policy rules comprise an option field for allowing the at least one network entity to send additional information to the firewall on at least one state to be created and the additional information is optionally used by the firewall to perform services on data travelling through the firewall.

13. The host system entity of claim 12, wherein the option field comprises at least one code for indicating the type of information stored in the option field and at least one value for the information identified by the at least one code.

14. The host system of claim 13 wherein the option field comprises at least one code for indicating that a Security Parameter Index used in a IP security protocol is stored in the option field and at least one value for the Security Parameter Index identified by the at least one code.

15. The host systems of claim 13, wherein the option field comprises at least one code for indicating that at least one TCP sequence number used during TCP communication is stored in the option field and at least one value for the at least one TCP sequence number identified by the at least one code.

16. The host system of claim 12, wherein the option field comprises means for enabling the firewall to determine how many types of values are stored in the option fields.

17. The host system of claim 12, wherein the at least one network entity is a processing unit connected to a network.

18. A method for protecting systems connected to at least one firewall by providing additional information to the at least one firewall on states to be created, the method comprises the steps of:
transmitting policy rules from at least one network entity connected to the at least one firewall;
installing the policy rules on the at least one firewall, wherein the policy rules comprise an option field for allowing the at least one network entity to send additional information to the at least one firewall on at least one state to be created; and
optionally using the additional information by the at least one firewall to perform services on data travelling through the at least one firewall.

19. The method of claim 18 further comprising the step of storing, in the option field, at least one code for indicating the type of information in the option field and at least one value for the information identified by the at least one code.

20. The method of claim 19, further comprising the step of storing, in the option field, at least one code for indicating a Security Parameter Index used in a IP security protocol and at least one value for the Security Parameter Index identified by the at least one code.

21. The method of claim 19, further comprising the step of storing, in the option field, at least one code for indicating at least one TCP sequence number used during TCP communication and at least one value for the at least one TCP sequence number identified by the at least one code.

22. The method of claim 18, further comprising the step of using the option field to enable the firewall to determine how many types of values are stored in the option fields.

23. An apparatus for protecting systems connected to at least one firewall by providing additional information to the at least one firewall on states to be created, the method comprises the steps of:
transmitting means for transmitting policy rules from at least one network entity connected to the at least one firewall;
installation means for installing the policy rules on the at least one firewall, wherein the policy rules comprise an option field for allowing the at least one network entity to send additional information to the at least one firewall on at least one state to be created; and
implementation means for optionally using the additional information by the at least one firewall to perform services on data travelling through the at least one firewall.

24. The apparatus of claim 23 further comprising storage means for storing, in the option field, at least one code for indicating the type of information in the option field and at least one value for the information identified by the at least one code.

25. The apparatus of claim 23, further comprising utilization means for using the option field to enable the firewall to determine how many types of values are stored in the option fields.

26. The apparatus of claim 23, wherein the at least one network entity is a processing unit connected to a network.
